(19) United States
(12) Patent Application Publication
(10) Pub. No.: US 2024/0428590 A1
(43) Pub. Date: Dec. 26, 2024

(54) DEVICE CONTROL METHOD, DEVICE CONTROL APPARATUS, ELECTRONIC DEVICE, PROGRAM, AND MEDIUM

(71) Applicants: BEIJING BOE TECHNOLOGY DEVELOPMENT CO., LTD., Beijing (CN); BOE Technology Group Co., Ltd., Beijing (CN)

(72) Inventor: Junjie Zhao, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/273,565

(22) PCT Filed: Aug. 8, 2022
(86) PCT No.: PCT/CN2022/110889

§ 371 Date: Jul. 21, 2023

(30) Foreign Application Priority Data
Apr. 27, 2022 (CN) 202210452222.1

(51) Int. Cl. G06V 20/52; G06T 7/70; G06V 10/44; H04L 12/28

(52) U.S. Cl. CPC G06V 20/52; G06T 7/70; G06V 10/44; H04L 12/2829; G06V 2201/07

(57) ABSTRACT

A device control method, a device control apparatus, an electronic device, a program, and a medium provided by the present disclosure belong to the technical field of computers. The method includes: acquiring a scene image of a target space; acquiring a target scene type matching a target object in the scene image; acquiring a target device associated with the target object shown in the scene image; and controlling the target device according to a device control strategy.

### CROSS-REFERENCE TO RELATED APPLICATIONS

The present disclosure claims priority to Chinese patent application No. 202210452222.1, titled “DEVICE CONTROL METHOD, DEVICE CONTROL APPARATUS, ELECTRONIC DEVICE, PROGRAM, AND MEDIUM”, filed on Apr. 27, 2022 to the China National Intellectual Property Administration, the entire contents of which are incorporated herein by reference.

### TECHNICAL FIELD

The present disclosure belongs to the technical field of computers, in particular to a device control method, a device control apparatus, an electronic device, a program, and a medium.

### BACKGROUND

With the improvement of people's living standards, people's demand for smart devices is increasing. However, some device control processes also require the participation of a user (for example, the user is required to clearly indicate a control object), or the solution of automatically controlling devices can only achieve a simple automatic triggering, for example, an operation on a fixed device is executed by determining a state change of a sensor.

### SUMMARY

The present disclosure provides a device control method, a device control apparatus, an electronic device, a program, and a medium.

Some embodiments of the present disclosure provide a device control method, including: acquiring a scene image of a target space: acquiring a target scene type matching a target object in the scene image: acquiring a target device associated with the target object shown in the scene image; and controlling the target device according to a device control strategy.

Optionally, the controlling the target device according to a device control strategy includes: acquiring a device image of the target device: acquiring a corresponding relationship between device images and device identifications: determining a device identification of the target device according to the corresponding relationship between device images and device identifications; and sending a control instruction carrying the device identification to the target device to control the target device.

Optionally, the controlling the target device according to a device control strategy includes: acquiring a device image feature of the target device: acquiring a corresponding relationship between device image features and device identifications: determining a device identification of the target device according to the corresponding relationship between device image features and device identifications; and sending a control instruction carrying the device identification to the target device to control the target device.

Optionally, before acquiring the device image of the target device, the method further includes at least one of: establishing the corresponding relationship between device identifications and device images; and establishing the corresponding relationship between device identifications and device image features.

Optionally, the establishing the corresponding relationship between device identifications and device images includes: acquiring the device identifications: triggering devices to start a positioning mode and acquiring the device images of the devices; and establishing the corresponding relationship between device images and device identifications; the establishing the corresponding relationship between device identifications and device image features includes: acquiring the device identifications: triggering devices to start the positioning mode and acquiring the device images of the devices: acquiring the device image features of the devices from the device images; and establishing the corresponding relationship between device image features and device identifications.

Optionally, the establishing the corresponding relationship between device identifications and device images includes: acquiring device images of devices: identifying a device type of the devices: acquiring the device identifications of the device type through a device discovery command; and establishing the corresponding relationship between device images and device identifications: the establishing the corresponding relationship between device identifications and device image features includes: acquiring device images of devices; acquiring the device image features of the devices from information about the device images; identifying the device type of the devices: acquiring the device identifications of the device type through a device discovery command; and establishing the corresponding relationship between device image features and device identifications.

Optionally, the controlling the target device according to a device control strategy includes: acquiring a device spatial position of the target device: acquiring a corresponding relationship between device spatial positions and device identifications: determining a device identification of the target device according to the corresponding relationship between device spatial positions and device identifications; and sending a control instruction carrying the device identification to the target device to control the target device.

Optionally, before acquiring the device spatial position of the target device, the method further includes: acquiring device spatial positions of devices; and establishing the corresponding relationship between device identifications and device spatial positions.

Optionally, the acquiring device spatial positions of devices includes: acquiring the device spatial positions of the devices according to a horizontal position and a vertical position of an image acquisition device as well as positions of the devices in an image.

Optionally, the acquiring a target device associated with the target object shown in the scene image includes: identifying at least one candidate device associated with the target object in the scene image; and screening out at least one target device satisfying a device control condition from the at least one candidate device.

Optionally, the screening out at least one target device satisfying a device control condition from the at least one candidate device includes: calculating a spatial distance between each candidate device and the target object in the scene image; and taking the candidate device having the spatial distance less than a first threshold as the target device.

Optionally, the screening out at least one target device satisfying the device control condition from the at least one candidate device includes: calculating a spatial distance between each candidate device and the target object in the scene image; and taking a candidate device that is turned off and has a distance to the target object less than a second threshold as the target device.

Optionally, the controlling the target device according to a device control strategy includes: acquiring a device control strategy corresponding to the target scene type; and controlling the at least one target device to switch from a current operation state to a target operation state according to the device control strategy.

Optionally, the acquiring a target scene type matching a target object in the scene image includes: identifying objects in the scene image: when an object is identified as the target object, performing a scene identification on the scene image to obtain the scene type; and taking the scene type as the target scene type.

Optionally, the acquiring a target scene type matching a target object in the scene image includes: performing a scene identification on the scene image to obtain the scene type; identifying objects in the scene image; and when an object is identified as the target object, taking the scene type as the target scene type.

Optionally, the performing a scene identification on the scene image includes: inputting the scene image into a scene identification model for identification, and obtaining the scene type of the scene image.

Optionally, the performing a scene identification on the scene image includes: inputting a user posture feature in the scene image into a posture identification model for identification, and obtaining the scene type corresponding to a current posture of a character.

Optionally, the object being identified as the target object includes: identifying objects contained in the scene image; and when there are at least two objects, taking an object with a highest priority as the target object.

Optionally, before acquiring a scene image of a target space, the method further includes: receiving a usage state notification message sent by a user through a device; and in response to the usage state notification message, triggering an execution process of device control.

Optionally, the acquiring a scene image of a target space includes: acquiring the scene image of the target space from an image acquisition device in the target space; or obtaining the scene image by shooting the target space.

Some embodiments of the present disclosure provide a device control apparatus, including:
an acquisition module, configured to acquire a scene image of a target space;
a scene identification module, configured to acquire a target scene type matching a target object in the scene image;
a device identification module, configured to acquire a target device associated with the target object shown in the scene image; and
a control module, configured to control the target device according to a device control strategy.

Optionally, the control module is further configured to:
acquire a device image of the target device;
acquire a corresponding relationship between device images and device identifications;
determine the device identification of the target device according to the corresponding relationship between the device image and the device identification; and
send a control instruction carrying the device identification to the target device to control the target device.

The control module is further configured to:
acquire a device image feature of the target device;
acquire a corresponding relationship between device image features and device identifications;
determine the device identification of the target device according to the corresponding relationship between device image features and device identifications; and
send a control instruction carrying the device identification to the target device to control the target device.

Optionally, the apparatus further includes a configuration module configured to:
establish the corresponding relationship between device identifications and device images; or

establish the corresponding relationship between device identifications and device image features.

Optionally, the configuration module is further configured to:
acquire a device identification;
trigger the device to start a positioning mode and acquire the device image of the device; and
establish a corresponding relationship between the device image and the device identification.

The configuration module is further configured to:
acquire a device identification;
trigger the device to start a positioning mode and acquire the device image of the device;
acquire a device image feature of the device from the device image; and
establish a corresponding relationship between the device image feature and the device identification.

Optionally, the configuration module is further configured to:
acquire a device image of a device;
identify a device type of the device;
acquire a device identification of the device type through a device discovery command; and
establish a corresponding relationship between the device image and the device identification.

The configuration module is further configured to:
acquire a device image of the device;
acquire a device image feature of the device from information about the device image; identify a device type of the device;
acquire a device identification of the device type through a device discovery command; and
establish a corresponding relationship between the device image feature and the device identification.

Optionally, the control module is further configured to:
acquire a device spatial position of the target device;
acquire a corresponding relationship between the device spatial position and the device identification;
determine the device identification of the target device according to the corresponding relationship between the device spatial position and the device identification; and
send a control instruction carrying the device identification to the target device to control the target device.

Optionally, the apparatus further includes a configuration module configured to:
acquire a device spatial position of the device; and
establish a corresponding relationship between the device identification and the device spatial position.

Optionally, the control module is further configured to:
acquire the device spatial position of the device according to a horizontal position and a vertical position of the image acquisition device and the position of the device in the image.

Optionally, the device identification module is further configured to:
identify at least one candidate device associated with the target object in the scene image; and
screen at least one target device satisfying a device control condition from the at least one candidate device.

Optionally, the device identification module is further configured to:
calculate a spatial distance between each candidate device and the target object in the scene image; and
take the candidate device having a spatial distance less than the first threshold as the target device.

Optionally, the device identification module is further configured to:
calculate a spatial distance between each candidate device and the target object in the scene image; and
take a candidate device that is turned off and has a distance to the target object less than a second threshold as the target device.

Optionally, the control module is further configured to:
acquire a device control strategy corresponding to the target scene type; and
control at least one target device to switch from the current operation state to a target operation state according to the device control strategy.

Optionally, the scene identification module is further configured to:
identify an object in the scene image;
when the object is identified as the target object, perform a scene identification on the scene image to obtain a scene type; and
take the scene type as a target scene type.

Optionally, the scene identification module is further configured to:
obtain a scene type by performing a scene identification on the scene image;
identify an object in the scene image; and
when the object is identified as a target object, take the scene type as the target scene type.

Optionally, the scene identification module is further configured to:
input the scene image into a scene identification model for identification, and obtain the scene type of the scene image.

Optionally, the scene identification module is further configured to:
input a user posture feature in the scene image into a posture identification model for identification, and obtain the scene type corresponding to the current posture of a character.

Optionally, the scene identification module is further configured to:
identify an object contained in the scene image; and
when there are at least two objects, take the object with the highest priority as the target object.

Optionally, the acquisition module is further configured to:
receive a usage state notification message sent by a user through a device; and
in response to the usage state notification message, trigger an execution of device control.

Optionally, the acquisition module is further configured to:
acquire a scene image of the target space from an image acquisition device in the target space;
or, shoot the target space to obtain the scene image.

Some embodiments of the present disclosure provide a computing processing device, including:

a memory storing with computer readable codes; and

one or more processors, wherein when the computer readable codes are executed by the one or more processors, the computing processing device executes the device control method described above.

Some embodiments of the present disclosure provide a computer program including computer readable codes that, when running on a computing processing device, cause the computing processing device to execute the device control method described above.

Some embodiments of the present disclosure provide a non-transient computer-readable medium storing a computer program of the device control method described above.

The above description is merely an overview of the technical solutions of the present disclosure. In order to know about the technical means of the present disclosure more clearly and implement the solutions according to the contents of the specification, and in order to make the above-mentioned and other objects, features and advantages of the present disclosure more apparent and understandable, specific implementations of the present disclosure are set forth below.

### BRIEF DESCRIPTION OF THE DRAWINGS

In order to describe the embodiments of the present disclosure or the technical solutions in the related art more clearly, the accompanying drawings which are used in the description of the embodiments or the related art will be briefly introduced. Apparently, the accompanying drawings in the following description illustrate some embodiments of the present disclosure, and those skilled in the art may obtain other accompanying drawings according to these accompanying drawings without paying any creative effort.

FIG. 1 is a schematic flow diagram schematically illustrating a device control method provided by some embodiments of the present disclosure;

FIG. 2 is a first schematic flow diagram schematically illustrating another device control method provided by some embodiments of the present disclosure;

FIG. 3 is a second schematic flow diagram schematically illustrating another device control method provided by some embodiments of the present disclosure;

FIG. 4 is a third schematic flow diagram schematically illustrating another device control method provided by some embodiments of the present disclosure;

FIG. 5 is a fourth schematic flow diagram schematically illustrating another device control method provided by some embodiments of the present disclosure;

FIG. 6 is a fifth schematic flow diagram schematically illustrating another device control method provided by some embodiments of the present disclosure;

FIG. 7 is a sixth schematic flow diagram schematically illustrating another device control method provided by some embodiments of the present disclosure;

FIG. 8 is a seventh schematic flow diagram schematically illustrating another device control method provided by some embodiments of the present disclosure;

FIG. 9 is an eighth schematic flow diagram schematically illustrating another device control method provided by some embodiments of the present disclosure;

FIG. 10 is a ninth schematic flow diagram schematically illustrating another device control method provided by some embodiments of the present disclosure;

FIG. 11 is a tenth schematic flow diagram schematically illustrating another device control method provided by some embodiments of the present disclosure;

FIG. 12 is an eleventh schematic flow diagram schematically illustrating another device control method provided by some embodiments of the present disclosure;

FIG. 13 is a twelfth schematic flow diagram schematically illustrating another device control method provided by some embodiments of the present disclosure;

FIG. 14 is a thirteenth schematic flow diagram schematically illustrating another device control method provided by some embodiments of the present disclosure;

FIG. 15 is a fourteenth schematic flow diagram schematically illustrating another device control method provided by some embodiments of the present disclosure;

FIG. 16 is a fifteenth schematic flow diagram schematically illustrating another device control method provided by some embodiments of the present disclosure;

FIG. 17 is a first schematic logic diagram schematically illustrating a device control method provided by some embodiments of the present disclosure;

FIG. 18 is a second schematic logic diagram schematically illustrating a device control method provided by some embodiments of the present disclosure;

FIG. 19 is a third schematic logic diagram schematically illustrating a device control method provided by some embodiments of the present disclosure;

FIG. 20 is a fourth schematic logic diagram schematically illustrating a device control method provided by some embodiments of the present disclosure;

FIG. 21 is a schematic scenario diagram schematically illustrating a device control method provided by some embodiments of the present disclosure;

FIG. 22 is a schematic structural diagram schematically illustrating a device control apparatus provided by some embodiments of the present disclosure;

FIG. 23 is a block diagram schematically illustrating a computing processing device for executing a method according to some embodiments of the present disclosure; and

FIG. 24 schematically shows a storage unit for holding or carrying program codes implementing a method according to some embodiments of the present disclosure.

### DETAILED DESCRIPTION OF THE EMBODIMENTS

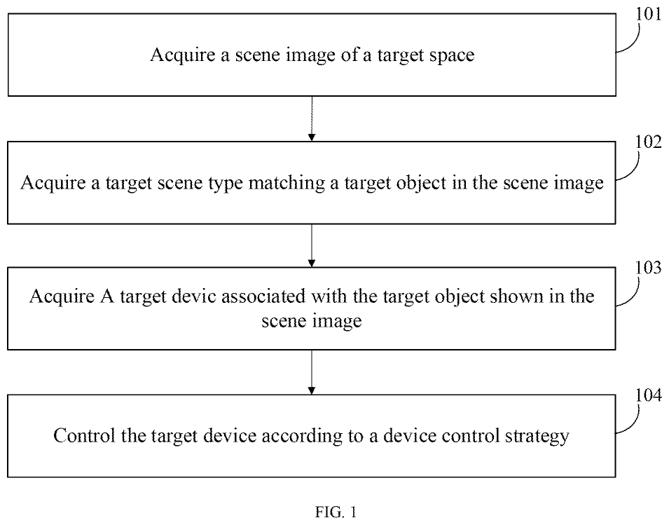

In order to make the objects, technical solutions, and advantages of the embodiments of the present disclosure clearer, the technical solutions in the embodiments of the present disclosure will be clearly and thoroughly described below in conjunction with the accompanying drawings in the embodiments of the present disclosure. Apparently, the described embodiments are a part of the embodiments of the present disclosure, rather than all the embodiments. Based on the embodiments of the present disclosure, all other embodiments obtained by those skilled in the art without paying any creative effort are within the scope of the present disclosure. FIG. 1 is a schematic flow diagram schematically illustrating a device control method provided by the present disclosure. The method includes steps described below.

At step 101, a scene image of a target space is acquired.

It needs to be noted that the executive subject of the device control method according to the present disclosure is a service endpoint, and the service endpoint may be a server or a terminal device. The terminal device has functions of data processing, data transmission and data storage, and is externally connected to or internally provided with an image acquisition module, for example a device including an image acquisition module such as a camera head and a camera, or smart appliances with an image capturing function, or personal computers with an external camera, and the like. The server has functions of data processing, data transmission, and data storage, and is connected to the terminal device via a network, and the terminal device is externally connected to or integrated with an image acquisition module. The target space refers to a visual range of the image acquisition module/device, for example an area, a place, etc. covered by the visual range of a lens.

In the embodiment of the present disclosure, the service endpoint acquires the scene image by continuously shooting the target space through a connected image acquisition device or module, or acquires the scene image by controlling the image acquisition device to shoot the target space according to a certain time period. It is worth mentioning that the scene image may be an image including a part or all of the space in the target space. When the image acquisition device can only acquire the scene image of a part of the space through a single shooting, in order to achieve the purpose of acquiring the scene image of the entire space in the target space, the image acquisition device can be controlled to adjust the shooting angle to perform multiple shootings of the target space so as to acquire multiple scene images reflecting different partial spaces in the target space. Of course, the image acquisition device or module connected to the service endpoint can be applicable to the embodiments of the present disclosure as long as the image acquisition device or module can shoot the target space. Specifically, it can be set according to actual needs, which will not be limited herein.

At step 102, a target scene type matching a target object in the scene image is acquired.

It needs to be noted that the target object may be a character, an article, a pet and the like in the scene image, and the target object may be input by the service endpoint in advance or may be input by a user himself.

In the embodiments of the present disclosure, the service endpoint can acquire a character included in the scene image as the target object by identifying a character image in the scene image through a face recognition technology. Certainly, considering that the face recognition technology has a high requirement for the image quality of a face in the image, the identity of a character can also be identified via character features such as a clothing feature, a physical feature, and a sound feature so as to improve the accuracy of the identity identification of the character. It is worth noting that in the present disclosure, the condition for triggering character object recognition by the service endpoint is that a character is presented in the scene image. However, the identity recognition mode for the character includes but is not limited to a recognition based on the scene image, and can also be other identity recognition technologies such as voice recognition and fingerprint recognition, which can be specifically set according to actual requirements, and is not limited herein.

It needs to be noted that a scene type is identification information for characterizing scene features, for example, the scene type may be a reading scene, a dining scene, a sports scene, a washing scene, etc. The service endpoint may screen out a target scene type included in the scene image from several preset scene types by: comparing image features in the scene image with scene features corresponding to different scene types, or identifying the same through a machine model obtained by training sample scene features marked with a scene type.

At step 103, a target device associated with the target object shown in the scene image is acquired.

In the embodiment of the present disclosure, in one implementation mode, the target device is associated with the target scene type, and different target scenes are associated with different target devices. For example, the target device in the reading scene is a lamp, and the target device in the sports scene is a speaker. In another implementation mode, the target device is associated with the target object, and different target objects are associated with different target devices. For example, a child is associated with a device in the study room of the child, an adult is associated with a device in the bedroom of the adult. The target device is an electronic device for which a corresponding relationship with the target object (for example, a target user) has been established in advance, and may be an electronic device in the target space or an electronic device outside the target space. The corresponding relationship between the target object and the device can be set when the information about the target object is entered, or when a device control strategy is entered, so that the target object controls the target device according to its own requirements.

At step 104, the target device is controlled according to a device control strategy.

In the embodiment of the present disclosure, device control strategies corresponding to different scene types are pre-set on the service endpoint, and the device control strategies may be pre-entered on the service endpoint, or may be entered by a user and set with corresponding scene types. The service endpoint verifies the device information about the target device associated with the target object according to the device control strategy, and sends a control instruction to an external control interface of the target device based on the device control strategy when the control requirement of the device control strategy is met, so as to control the target device to execute the control instruction, thereby achieving automatic control of the target device. The device control strategy is a device control mode in different scenes, for example powering on a desk lamp device in the reading scene and powering off the desk lamp device in a scene other than the reading scene. Of course, the device control strategy can also be performing controlling according to a positional relationship between a user and a device associated with the user, for example, powering on a lighting device that is closer to the user in the reading scene, and powering on a speaker device that is closest to the user in the sports scene.

In the embodiments of the present disclosure, according to a captured scene image of the target space, a type of a scene where a target object is located is automatically determined after the target object enters the target space, and a device control strategy is adopted to control a device associated with the target object, so as to automatically control the device associated with the target object based on the usage scenario of the target object, making it easy to control the electronic device without performing operations during each use.

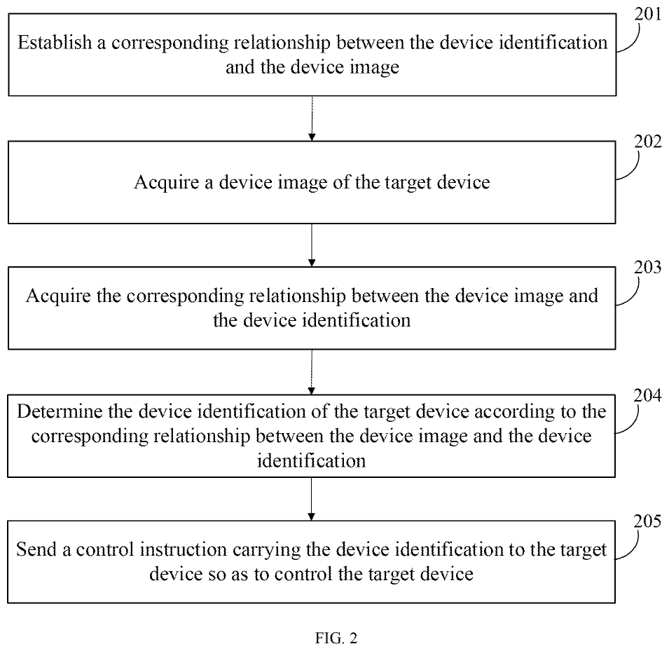

Optionally, referring to FIG. 2, step 104 includes steps described below.

At step 201, a corresponding relationship between device identifications and device images is established.

In the embodiment of the present disclosure, a device identification is a unique identification for indicating the device, and a device image is image information obtained by shooting the device. The corresponding relationship between device identifications and device images is constructed in advance on the service endpoint, and is stored on the service endpoint or other storage device, which can be specifically set according to actual requirements, and is not limited herein.

At step 202, the device image of the target device is acquired.

At step 203, the corresponding relationship between device images and device identifications is acquired.

At step 204, the device identification of the target device is determined according to the corresponding relationship between device images and device identifications.

In the embodiment of the present disclosure, the service endpoint may shoot a device presented in the target space to acquire a device image, and then query a device identification of the device image in the corresponding relationship between device images and device identifications, so as to be used in a subsequent device automation control.

At step 205, a control instruction carrying the device identification is sent to the target device so as to control the target device.

In the embodiment of the present disclosure, the service endpoint carries the device identification in the control instruction, so that the target device corresponding to the device identification executes the control instruction according to the device identification, thereby realizing automatic device control.

Specifically, since a device image is to be acquired, the image acquisition device connected to the service endpoint may be a general camera as long as it is capable of capturing images and/or videos. Furthermore, the camera can acquire the device image, and can also acquire the device identification by triggering a device positioning mode, thereby establishing a corresponding relationship between device images and device identifications, and in particular a corresponding relationship between device image IDs and device identifications. After the corresponding relationship is established, the camera can acquire a device image in real time, and compare the device image acquired in real time with device images that are saved when the corresponding relationship is established, so as to determine the similarity between the two device images. When the similarity is greater than a certain threshold, it is considered that the target device has been acquired. This approach is suitable for application scenarios where the target device has less changes in the position and/or environment.

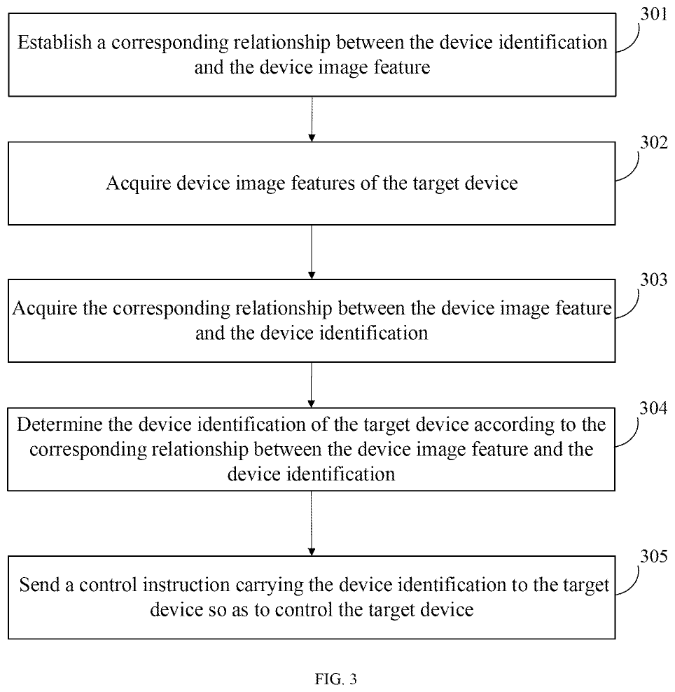

Optionally, referring to FIG. 3, step 104 includes steps described below.

At step 301, a corresponding relationship between device identifications and device image features is established.

In the embodiment of the present disclosure, a device identification is a unique identification for indicating the device, and a device image feature is a feature value, e.g., a feature vector, of the image information obtained from shooting the device. The corresponding relationship between device identifications and device image features is constructed in advance on the service endpoint, and stored on the service endpoint or other storage device, which can be specifically set according to actual requirements, and is not limited herein.

At step 302, a device image feature of the target device is acquired.

At step 303, the corresponding relationship between device image features and device identifications is acquired.

At step 304, the device identification of the target device is determined according to the corresponding relationship between device image features and device identifications.

In the embodiment of the present disclosure, the service endpoint may shoot a device existed in the target space to acquire a device image, extract a device image feature from the device image, and then, in the corresponding relationship between device image features and device identifications, query a device identification corresponding to the device image feature, so as to be used for subsequent automatic device control. It needs to be noted that compared with the device identification query mode based on the device image, the device image feature requires a low accuracy for the shot scene image, thereby improving the accuracy of automatic device control.

At step 305, a control instruction carrying the device identification is sent to the target device so as to control the target device.

This step can refer to the detailed description of step 204, and will not be repeated herein.

Specifically, since a device image feature is to be acquired, the image acquisition device connected to the service endpoint needs to be a smart camera. In other words, the image acquisition device may be installed with an intelligent recognition algorithm, such that the image feature information (e.g., information about feature points on a human face) of a target (which may be a person/animal or article) can be directly acquired, and then the image feature information is compared with a feature database, thereby realizing the function of recognizing the target object. Furthermore, the smart camera can acquire the device image feature, and can also acquire the device identification by triggering the device positioning mode, thereby establishing the corresponding relationship between device image features and device identifications. After the corresponding relationship is established, the smart camera can acquire the device image feature in real time, and can accurately determine whether the acquired device image feature is the image feature of the target device. Since the accuracy of the device image feature extracted by the smart camera is high, the method is suitable for the application scene where the position and/or environment of the target device changes.

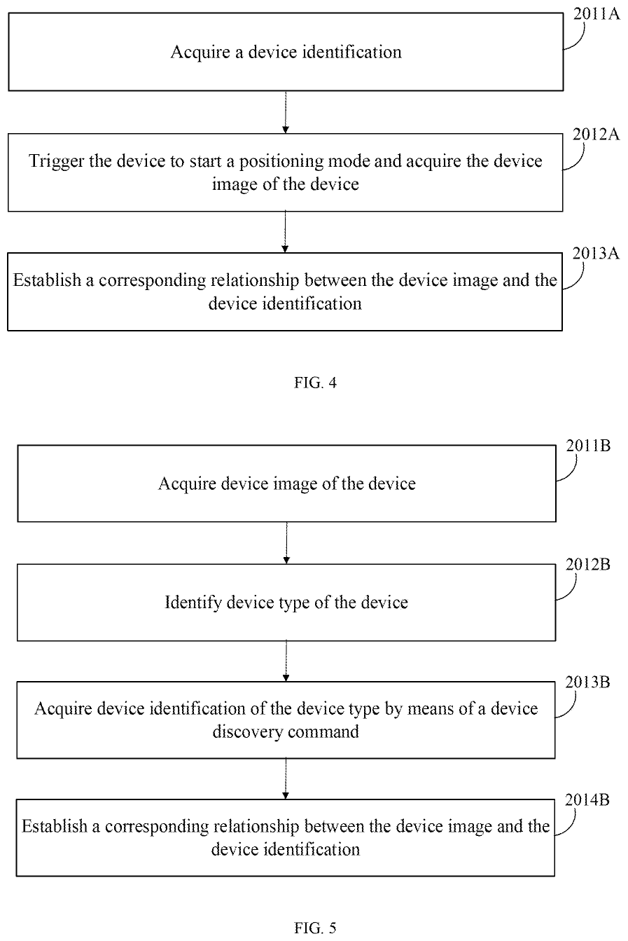

Optionally, referring to FIG. 4, step 201 includes steps below.

At step 2011A, a device identification is acquired.

At step 2012A, the device is triggered to start a positioning mode and the device image of the device is acquired.

At step 2013A, a corresponding relationship between device images and device identifications is established.

In the embodiment of the present disclosure, the device identification may be pre-set. For example, the device identification is input by a user when the service endpoint is configured, and the device identification is the device model, device name and the like input by the user. Alternatively, the device identification may be acquired through a device discovery protocol, e.g., discovering the device through the device discovery protocol, including the device identification. After the device identification has been acquired, the service endpoint triggers the device to start the positioning mode. In the positioning mode, the device highlights its own position by means of optical, sound, and like manners so that the service endpoint extracts the device image from the acquired scene image or highlights the device. Specifically, the camera finds device of a specific device type (for example, a lighting device) via a DNS-SD protocol, acquires identification information, device description information, service description information, etc. about the device, and then the device is controlled via a device control protocol to start the positioning mode, and the image information about the device under the positioning mode is acquired by the camera, so as to establish a corresponding relationship between device images and device identifications.

Optionally, referring to FIG. 5, step 201 includes steps below.

At step 2011B, a device image of the device is acquired.

At step 2012B, a device type of the device is identified.

At step 2013B, a device identification of the device type is acquired through a device discovery command.

At step 2014B, a corresponding relationship between device images and device identifications is established.

In the embodiment of the present disclosure, compared with the method in steps 2011A to 2013A, the difference lies in that the device image is acquired first and then the device identification is acquired in the embodiment of the present disclosure. The service endpoint can automatically perform image acquisition on devices in the target space so as to acquire device images in the target space, and then trigger the acquired device to start the positioning mode, so as to establish a corresponding relationship between device images and device identifications. In another embodiment, the service endpoint acquires the device image in the target space, identifies the device image, identifies the type of the device, and then acquires device information belonging to the device type through the device discovery protocol (such as the DNS-SD protocol), and controls the discovered device to start the positioning mode via the device, thereby establishing the corresponding relationship between device images and device identifications.

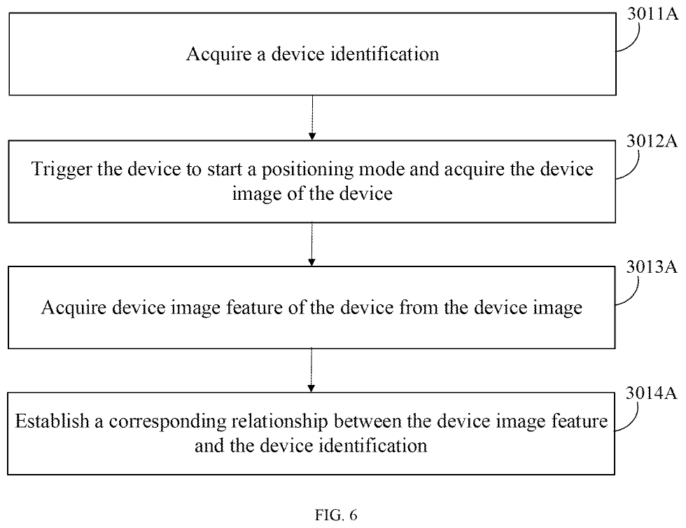

Optionally, referring to FIG. 6, step 301 includes steps below.

At step 3011A, a device identification is acquired.

At step 3012A, the device is triggered to start a positioning mode and a device image of the device is acquired.

At step 3013A, a device image feature of the device is acquired from the device image.

At step 3014A, a corresponding relationship between device image features and device identifications is established.

Different from steps 2011A to 2013A, in the embodiment of the present disclosure, after the device image is acquired, the device image feature is further extracted from the device image, and the corresponding relationship between device image features and device identifications is established. Compared with the method of establishing the corresponding relationship between device images and device identifications, the target device identification can be quickly determined, and the execution efficiency of the method can be improved. Moreover, by using the device image feature, the method avoids directly saving the device image, which is beneficial to improving information security.

Optionally, referring to FIG. 7, step 301 includes steps below.

At step 3011B, a device image of the device is acquired.

At step 3012B, a device image feature of the device is acquired according to information about the device image.

At step 3013B, a device type of the device is identified.

At step 3014B, a device identification of the device type is acquired through a device discovery command.

At step 3015B, a corresponding relationship between device image features and device identifications is established.

Different from steps 2011B to 2014B, in the embodiment of the present disclosure, after the device image is acquired, the device image feature is further extracted from the device image, and the corresponding relationship between device image features and device identifications is established. Compared with the method of establishing a corresponding relationship between device images and device identifications, the device image feature has a lower requirement for the shooting accuracy of the image acquisition device, and thus the accuracy of automatic device control can be improved.

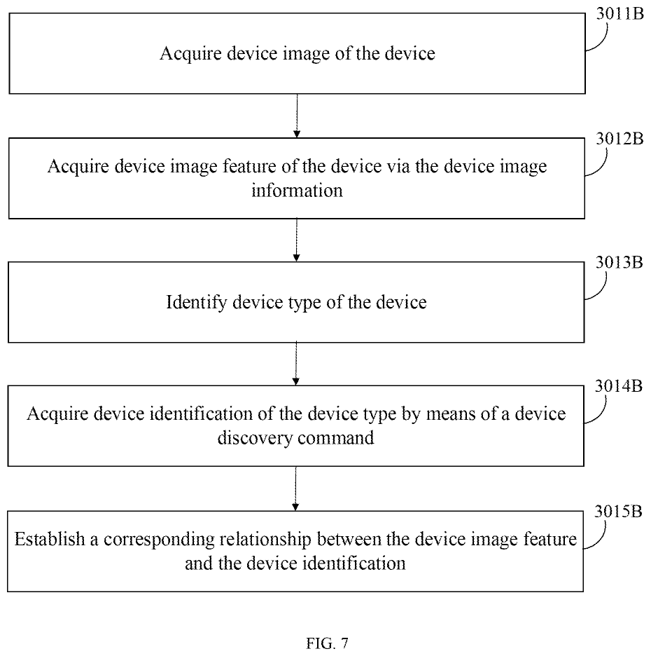

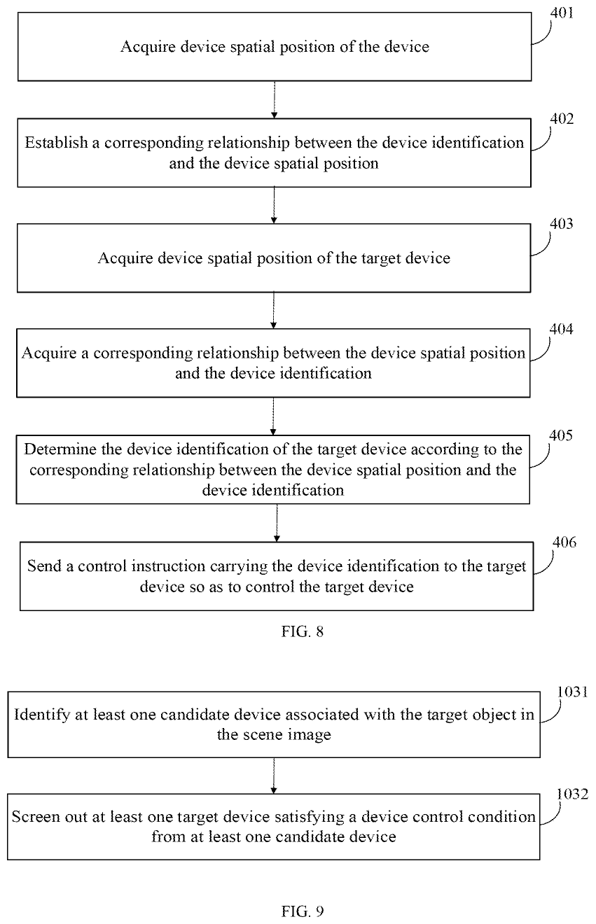

Optionally, referring to FIG. 8, step 104 includes steps below:

At step 401, a device spatial position of the device is acquired.

At step 402, a corresponding relationship between device identifications and device spatial positions is established.

In the embodiment of the present disclosure, a device spatial position is position information for indicating an orientation of the device in the target space. The corresponding relationship between device identifications and device spatial positions is constructed in advance on the service endpoint and stored on the service endpoint or other storage device, which can be specifically set according to actual requirements, and is not limited herein. Specifically, the device spatial position may change, and a corresponding relationship between the device and device image needs to be established: a camera records the current angle (a horizontal steering angle and a vertical steering angle), and at the same time, the camera records the coordinate of the device in the current image: furthermore, a networking device can acquire feature information about the device via the camera, and then establish a corresponding relationship between the device and the image: a camera three-dimensional coordinate system is constructed such that each object can use (θ1, θ2, x, y, z) to describe any position of the object.

At step 403, the device spatial position of the target device is acquired.

At step 404, the corresponding relationship between device spatial positions and device identifications is acquired.

At step 405, the device identification of the target device is determined according to the corresponding relationship between device spatial positions and device identifications.

In the embodiment of the present disclosure, the service endpoint calculates the device spatial position according to the position where the device is located in the scene image shot by the image acquisition device, so as to query the device identification according to the corresponding relationship between device spatial positions and device identifications, which can then be used in the subsequent automatic device control.

At step 406, a control instruction carrying the device identification is sent to the target device, so as to control the target device.

According to the present disclosure, the device is identified according to the device spatial position, so that an image accuracy requirement for a scene image acquired by the image acquisition device is reduced. The device can be accurately identified according to the identified device spatial position, thereby improving the automation control accuracy of the device.

Optionally, step 401 includes: acquiring the device spatial position of the device according to the horizontal position and the vertical position of the image acquisition device and the position of the device in the image.

Optionally, referring to FIG. 9, step 103 includes steps below.

At step 1031, at least one candidate device associated with the target object in the scene image is identified.

At step 1032, at least one target device satisfying a device control condition is screened out from the at least one candidate device.

It needs to be stated that the device control condition refers to a condition for performing automatic control on the device. A determination factor of the device control condition may be a scene factor such as the current time point, ambient temperature, ambient light intensity, or may also be a device factor such as the current operation state of the device, device position, or may be a user factor such as an activity mode, a posture feature of a person, or a comprehensive factor such as an interrelationship between the device and the person, which may be specifically set according to actual requirements and is not limited herein. Furthermore, different device control conditions have corresponding target operation states, namely, when the current scene satisfies the device control condition, the device is controlled to be adjusted to the target operation state.

In the embodiment of the disclosure, the service endpoint identifies a list of candidate devices associated with the target object and includes device control conditions for automatically controlling different candidate devices, so as to select a target device corresponding to the device control conditions satisfied by the current scene.

Based on a target operation state corresponding to the device control condition, the service endpoint sends a control to an external control interface of the target device to enable the target device to switch to the target operation state. For example, when a user enters a room, the lighting device in the room is automatically powered on: if the lighting device is powered off, the lighting device is controlled to be powered on, and if the lighting device is in an on state, no action is performed: optionally, the air conditioner is controlled to perform cooling when the room temperature is greater than a high temperature threshold, and the air conditioner is controlled to perform heating when the room temperature is less than a low temperature threshold. Of course, this is merely an exemplary illustration, and specific device control conditions and target operation states may be set according to actual needs, and are not limited herein.

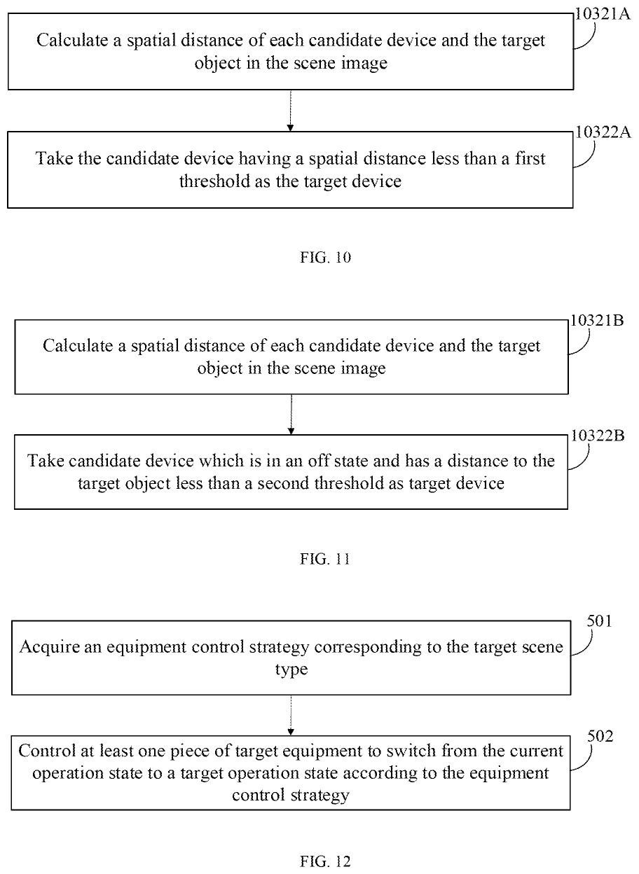

Optionally, referring to FIG. 10, step 1032 includes steps below.

At step 10321A, a spatial distance between each candidate device and the target object in the scene image is calculated.

At step 10322B, a candidate device for which a spatial distance is less than a first threshold is selected as the target device.

In the embodiment of the disclosure, the service endpoint may construct a three-dimensional coordinate system with the position of the image acquisition device as a reference position, record and save the coordinates of each device in the three-dimensional coordinate system as the position of the device. Further, the position of the device may change, and the image acquisition device calculates the device position of the device in the current scene image based on the current horizontal steering angle and the current vertical steering angle. Therefore, the spatial distance between the position of a person and the position of a device in the scene image is calculated, based on the distance between the position of the image acquisition device and the device position, according to the trigonometric function. When the spatial distance between the user and the target device reaches a enabling distance range, the target device may be automatically controlled. There may be multiple enabling distance ranges, and different enabling distance ranges may correspond to different enabling modes.

Optionally, referring to FIG. 11, step 1032 includes steps below.

At step 10321B, a spatial distance between each candidate device and the target object in the scene image is calculated.

At step 10322B, a candidate device that is turned off and has a distance less than a second threshold relative to the target object is selected as the target device.

In the embodiment of the disclosure, on the basis of turning on the target device according to the spatial distance determination and identification, the current on and off state of the target device may also be identified to avoid sending an invalid device control command. For example, when the target device is multiple lighting devices in a room, one or more lighting devices closest to the user is/are turned on, or one or more lighting devices is/are turned on randomly when the user enters the room. This is of course only an exemplary description, which may be specifically set according to actual requirements and is not limited thereto.

Optionally, referring to FIG. 12, step 104 includes steps below.

At step 501, a device control strategy corresponding to the target scene type is acquired.

At step 502, at least one target device is controlled, according to the device control strategy, to switch from the current operation state to a target operation state.

In the embodiment of the present disclosure, corresponding target operation states may be set for various device control strategies. For example, when the spatial distance between the user and the target device reaches an enabling distance range, the target device can be automatically controlled. There may be multiple enabling distance ranges, and different enabling distance ranges may correspond to different enabling modes. For example, when the target device is multiple lighting device in a room, one or more lighting device closest to the user is/are turned on, or one or more lighting device is/are turned on randomly when the user enters the room. This is of course only an exemplary description, which can be specifically set according to actual requirements and is not limited thereto.

The present disclosure is used for automatically controlling the device according to different device control strategies without requiring a user to actively perform a control operation, thereby improving the convenience of device control.

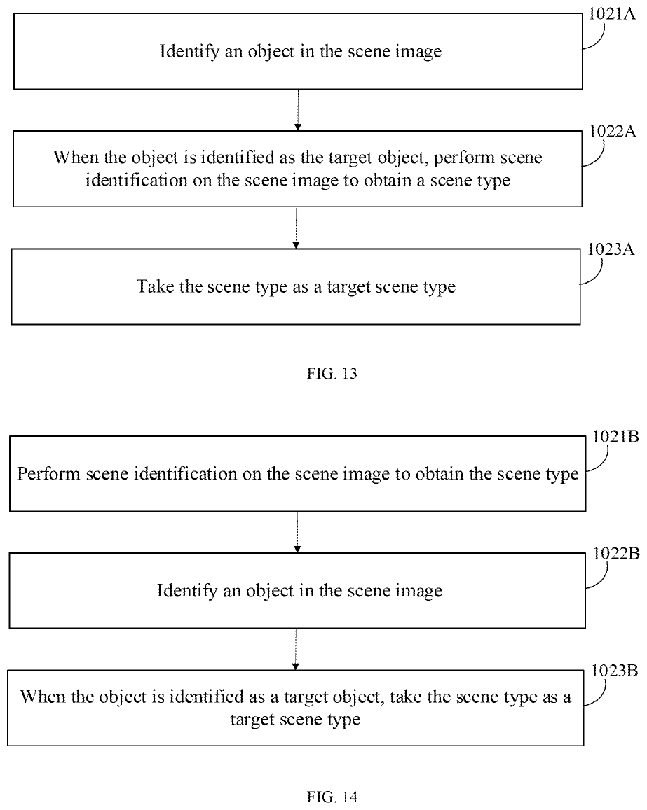

Optionally, referring to FIG. 13, step 102 includes steps below.

At step 1021A, an object in the scene image is identified.

At step 1022A, when the object is identified as the target object, a scene identification is performed on the scene image to obtain a scene type.

At step 1023A, the scene type is used as a target scene type.

In the embodiment of the present disclosure, objects in the scene image may be identified first, and the device type in the scene image is identified after a target object is identified. For example, when a user enters a room, the image acquisition device identifies a scene image obtained by shooting by the user and identifies the user, and then subsequent scene type identification and automation control flow of the device are triggered. Firstly, the objects in the scene image are identified such that the target object is quickly identified. Personalized services are provided for the target object to avoid identifying scene images of non-target-objects. In addition, the objects in the scene image are identified first, and then the scene image is identified when the target object is identified, which can quickly respond to the requirements of the target object and improve the efficiency because the calculation amount of the object identification is small, and the calculation amount of the scene identification is relatively large. When the number of target objects is small (for example, one), the target object can be quickly identified by identifying the objects in the scene image first, and identification of scene images of non-target-objects can be avoided by providing personalized services for the target object. Further, the objects in the scene image are identified first, and then the scene image is identified when the target object is identified, thereby quickly responding to the requirements of the target object and improving the efficiency.

Optionally, referring to FIG. 14, step 102 includes:

At step 1021B, a scene identification is performed on the scene image to obtain a scene type.

At step 1022B, objects in the scene image are identified.

At step 1023B, when an object is identified as the target object, the scene type is used as a target scene type.

In the embodiment of the present disclosure, compared with the above-mentioned embodiments of step 1021A to step 1023A, in the embodiment, the scene type in the scene image is identified first, and then the objects in the scene image are identified, that is to say, different scene types correspond to different target objects, and the target objects required to be identified are different when the scene types are different. For example, if the scene type is a child reading scene type, the target object is a child: if the scene type is a cooking scene type, the target object is an adult. It can be specifically set according to actual needs, and is not limited herein. The scene in the scene image is identified first such that the scene type is quickly identified, and the service can be provided for the target object. When there are multiple target objects (e.g., more than two target objects), the scene in the scene image is identified first such that the requirements of multiple target objects can be quickly met, improving the efficiency and user experience.

Optionally, step 1021A or step 1021B includes: inputting the scene image into a scene identification model for identification, and obtaining the scene type of the scene image.

In the embodiment of the present disclosure, the scene identification model may be a machine learning model with image identification capabilities or an algorithmic model for performing image feature comparison. Specifically, the scene type of a target user is identified image samples under different scene types are respectively acquired, and the scene type is marked for the image sample, then the service endpoint identifies the images that have been classified via a deep neural network system, and forms a depth identification algorithm to identify the scene type of the scene image.

For example, the partitioning of scene types is illustrated as an example with reference to the following Table 1:

TABLE 1

| Scene type | Description |
|---|---|
| Reading | Various circumstances of reading, including reading |
| | in a posture of sitting, reading in a posture of |
| | standing, reading in a posture of lying, reading in a |
| | posture of lying prone, etc. |
| Tooth brushing | Various circumstances of tooth brushing, including |
| | tooth brushing in a posture of sitting, tooth |
| | brushing in a posture of standing, etc. |
| Eating | eating at different positions and in different |
| | postures, including eating with chopsticks, eating |
| | with a knife and a fork, etc. |
| Sports | sports of different modes, including running, |
| | jumping, walking, squatting, etc. |
| . . . | . . . |

Optionally, step 1021A or step 1021B includes: inputting a user posture feature in the scene image into the posture identification model for identification, and obtaining a scene type corresponding to the current posture of the user.

In the embodiment of the present disclosure, considering that the image accuracy requirement for identifying a scene type through the overall feature of a scene image is high, the present disclosure can also use state features for identification. A preliminary determination of a user's behavior can be made via state identification, which can satisfy a scene with a low accuracy requirement. Specifically, feature information about postures of a character can be calculated and acquired by acquiring a scene picture or video containing the postures of the character. For example, state pictures or videos of reading, doing homework, playing with a platform and the like are acquired, and feature information contained in the pictures or videos is calculated: a user is connected to a service endpoint via a mobile terminal, so that the user's posture feature information is configured by the service endpoint. In this way, by means of submitting a picture of a video, if the character posture of the target user is already saved by the service endpoint, it can be set through a selected mode. Optionally, the user can directly connect a camera through a mobile terminal, and configure the posture feature information of the target user through the mobile terminal.

In the present disclosure, a scene identification model obtained by training with the user posture features is adopted to perform identification, thereby reducing the quality requirement of scene identification for an input image and improving the accuracy of scene identification.

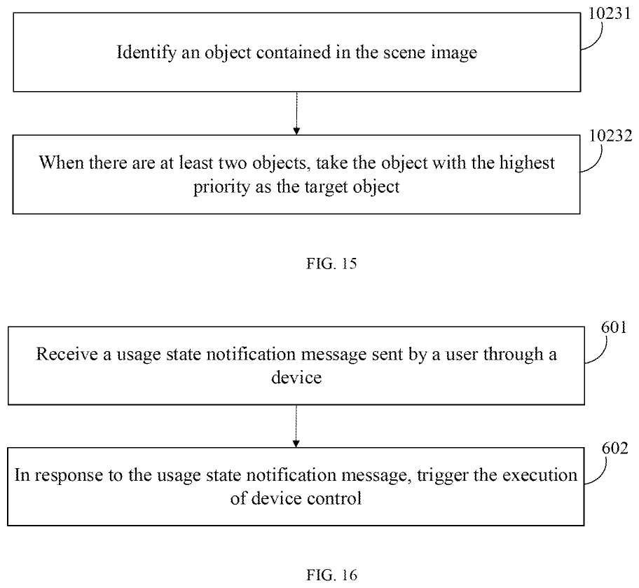

Optionally, referring to FIG. 15, step 1023A or step 1023B includes steps below:

At step 10231, objects included in the scene image are identified.

At step 10232, when there are at least two objects, an object with the highest priority is selected as the target object.

In the embodiment of the present disclosure, considering that when multiple characters present in a scene image, a logical conflict may occur between the device control strategies of different characters, in the present disclosure, corresponding priorities are set for different identity information, such that when there are multiple characters, the identity information of the character with the highest priority is taken as the target object actually used when device automation control is performed this time. Therefore, the problem that the automation control of the device is disturbed due to the conflict of device control strategies of different characters is avoided.

Optionally, referring to FIG. 16, prior to step 101, the method further includes steps below:

At step 601, a usage state notification message sent by a consumer device is received.

At step 602, in response to the usage state notification message, an execution process of the device control is triggered.

In the embodiment of the present disclosure, the consumer device may be a mobile phone, a tablet computer, a notebook computer, etc., of the user, and the user may trigger the usage state notification message on the consumer device, thereby causing the service endpoint and the device to enter the operation state based on the usage state notification message, and thus triggering the execution process of the service endpoint executing any step of the device control method described above in the present disclosure. Therefore, the user can easily trigger the automation control flow of the device.

Optionally, step 101 includes acquiring a scene image of the target space from an image acquisition device in the target space, or shooting the target space to obtain the scene image.

In the embodiment of the present disclosure, the scene image acquired by the service endpoint may be obtained by shooting a target space through an image acquisition function of itself, or may be sent to the service endpoint after being captured by a camera in the target space or other device having an image acquisition function.

Illustratively, for ease of understanding, the present disclosure provides various embodiments that may be implemented for reference.

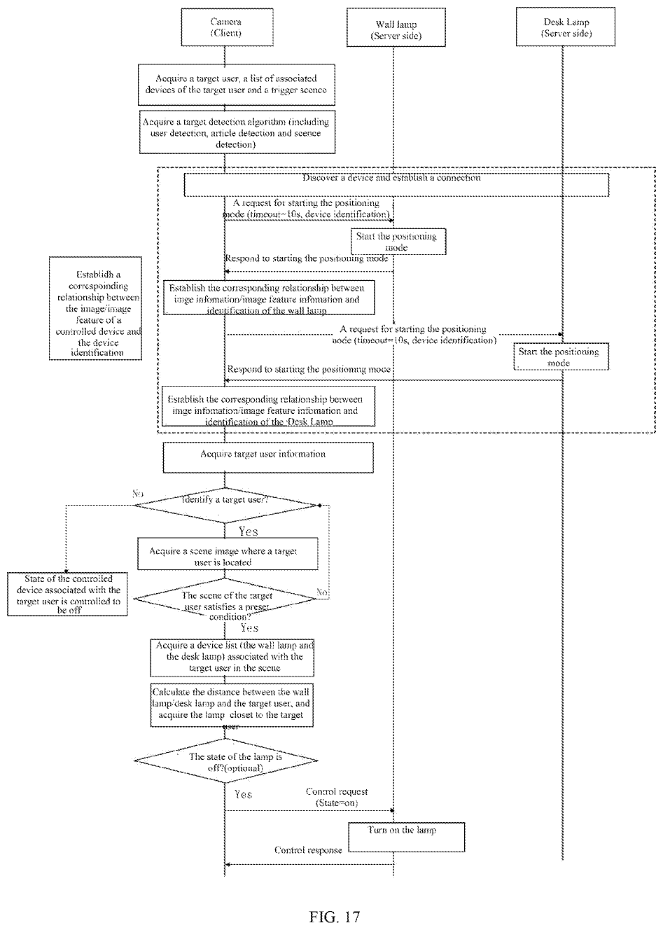

A first logic flow diagram of a device control method provided by the present disclosure is shown with reference to FIG. 17.

A camera acquires information such as a target user, a device associated with the target user, and a trigger scene. Specifically, a user sets a target user, a device associated with the target user, and a trigger scene through a camera server, and the camera acquires the above-mentioned information from the server. Alternatively, the user connects to a camera via a local network to set the target user, the device associated with the target user, and the trigger scene.

The camera acquires a target detection algorithm (including user detection, article detection, and scene detection) according to information set by the user, such as the target user, the device associated with the target user, and the trigger scene.

When the device associated with the target user input by the user is a device type (for example, a lighting device), the camera finds a lamp device via the device discovery protocol, and the camera may find multiple lamp devices at the same time. Specifically, the device broadcasts a device message via the DNS-SD, and the camera discovers the device via the DNS-SD so as to be able to interact with the device, and the camera records relevant information about the device, including information such as an identifier and a function: the camera sends a request for starting a positioning mode, and the request includes a device identification; in the positioning mode, the device highlights itself by means of light, sound, etc. so that the camera can determine the position of the device: the camera acquires image information about the device, and establishes a corresponding relationship between the device image/device image feature, and the device identification.

When the device associated with the target user input by the user is a device identification list, the camera sends a request for starting the positioning mode, and the request includes a device identification: in the positioning mode, the device highlights itself by means of light, sound, etc. so that the camera can determine the position of the device: the camera acquires image information about the device, and establishes a corresponding relationship between the device image/device image feature, and the device identification.

Optionally, the camera establishes a corresponding relationship between device identifications and device positions. Further, the position of the device may change, and it is necessary to establish a corresponding relationship between the device and the device image: the camera records the current angle (a horizontal steering angle and a vertical steering angle), and the camera also records the coordinate of the device in the current image: further, the networking device can acquire feature information about the device via the camera, and then a corresponding relationship between the device and the image is established: a camera three-dimensional coordinate system is constructed, and each object can use (θ1, θ2, x, y, z) to describe any position of the object.

The camera acquires target user information, and identifies the current user as the target user: if the target user is identified, the next step is executed: otherwise, the state of a controlled device associated with the target user is controlled to be turned off.

The camera acquires scene information about the target user, and determines whether the scene of the target user satisfies a pre-set condition: if the pre-set condition is satisfied, then the next step is executed, otherwise, the step of identifying the target user is executed. Specifically, the scene information about the target user is identified, the scenes in a family are classified first, and image samples in different classified scenes are acquired respectively, and the image samples are labeled, the camera or camera server identifies the classified images through a deep neural network system to form a depth identification algorithm.

The camera acquires a list of devices (for example, a wall lamp and a desk lamp) associated with the target user in the scene.

The camera calculates the distance between the associated device and the target user, and acquires the identification of an associated device closest to the target user (there may be multiple associated devices within a certain threshold); optionally, the camera acquires a three-dimensional coordinate of the lamp, and determines the distance between the lamp and the target user by calculating the three-dimensional coordinate of the lamp and the three-dimensional coordinate of the user; the camera determines a list of devices for which a distance relative to the current position of the target user is less than a certain threshold; when there is only one device in the list of devices, the device is controlled to be enabled; when multiple devices present in the list of devices, one of devices is randomly selected to be enabled.

Optionally, the state determined by the camera is turned-off, and the next step is executed when the state is turned-off.

The camera sends a control request to enable a lamp, for example, controlling a desk lamp closest to the target user to be enabled. Optionally, the camera acquires the data of other sensors to adjust the parameter of the terminal device being controlled, such as adjusting a brightness of the lamp.

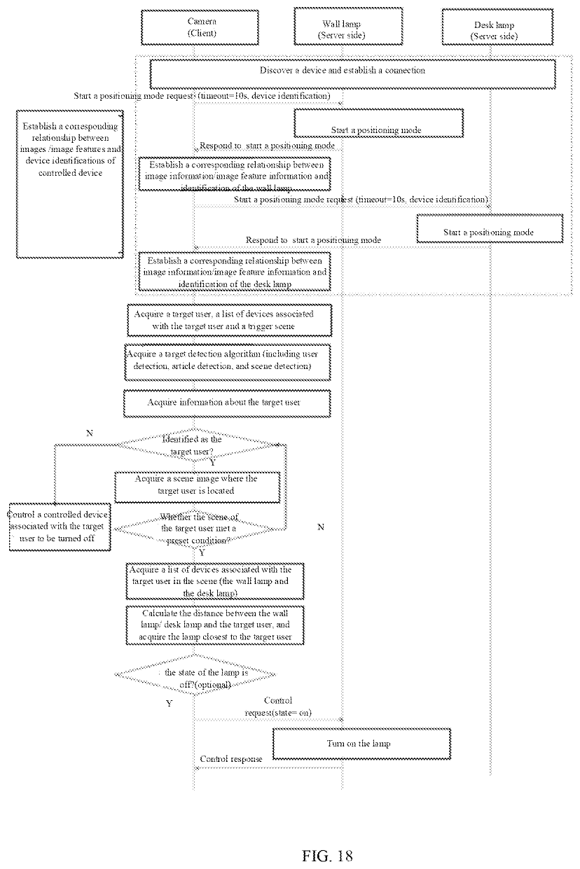

A second logic flow diagram of a device control method provided by the present disclosure is shown with reference to FIG. 18.

The camera discovers a device via the device discovery protocol, and the camera may discover multiple devices at the same time. Specifically, the device broadcasts a device message via the DNS-SD, and the camera discovers the device via the DNS-SD, so that the camera can interact with the device, and the camera records relevant information about the device, including information such as an identifier and a function.

The camera sends a request for starting the positioning mode, and the request includes a device identification. In the positioning mode, the device highlights itself by means of light, sound, etc., so that the camera can determine the position of the device.

The camera acquires image information about the device, and establishes a corresponding relationship between device images/device image features and device identifications.

The camera acquires information such as a target user, a device associated with the target user, and a trigger scene. Specifically, a user sets the target user, the device associated with the target user, and the trigger scene via a camera server, and the camera acquires the above-mentioned information from the server. Alternatively, the user connects to the camera via a local network to set the target user, the device associated with the target user, and the trigger scene.

The camera acquires a target detection algorithm (including user detection, article detection, and scene detection) according to the information set by the user, such as the target user, the device associated with the target user and the trigger scene.

When the device associated with the target user input by the user is the device type (for example, lighting device), the camera acquires the device identification and device image/device image feature of the device type: when the device associated with the target user input by the user is the device identification list, the camera acquires the device image/device image feature corresponding to the device identification.

Optionally, the camera establishes a corresponding relationship between device identifications and device positions. Further, the position of the device may change, and it is necessary to establish a corresponding relationship between the device and the device image. The camera records the current angle (a horizontal steering angle and a vertical steering angle), and the camera also records the coordinate of the device in the current image. Further, a networking device may acquire the feature information about the device via the camera, and then establishes a corresponding relationship between the devices and the images: a camera three-dimensional coordinate system is constructed, and each object may use (θ1, θ2, x, y, z) to describe any position of the object.

The camera acquires target user information, and identifies the current user as the target user: if the target user is identified, the next step is executed: otherwise, the state of a controlled device associated with the target user is controlled to be off.

The camera acquires scene information about the target user, and determines whether the scene of the target user satisfies a pre-set condition. If the pre-set condition is satisfied, then the next step is executed, otherwise, a step of identifying the target user is executed. Specifically, the scene information about the target user is identified, the scenes in a family are firstly classified and image samples from different classification scenes are acquired respectively, and the image samples are labeled, the camera or camera server identifies the classified images through a deep neural network system to form a depth identification algorithm.

The camera acquires a list of devices (for example, a wall lamp and a desk lamp) associated with the target user in the scene.

The camera calculates the distance between the associated device and the target user, and acquires the identification of an associated device closest to the target user (there may be multiple associated devices within a certain threshold). Optionally, the camera acquires a three-dimensional coordinate of the lamp, and determines the distance between the lamp and the target user by calculating the three-dimensional coordinate of the lamp and the three-dimensional coordinate of the user; the camera determines a list of devices for which the distance to the current position of the target user is less than a certain threshold: when there is only one device in the list of devices, the device is controlled to be enabled: when multiple devices are presented in the list of devices, one of the devices is randomly selected to be enabled.

Optionally, if it is determined by the camera that the state is off, the next step is executed.

The camera sends a control request to enable a lamp, for example, enable a desk lamp closest to the target user. Optionally, the camera acquires the data of other sensors, and adjusts parameters of the terminal device being controlled, for example adjusting the brightness of the lamp.

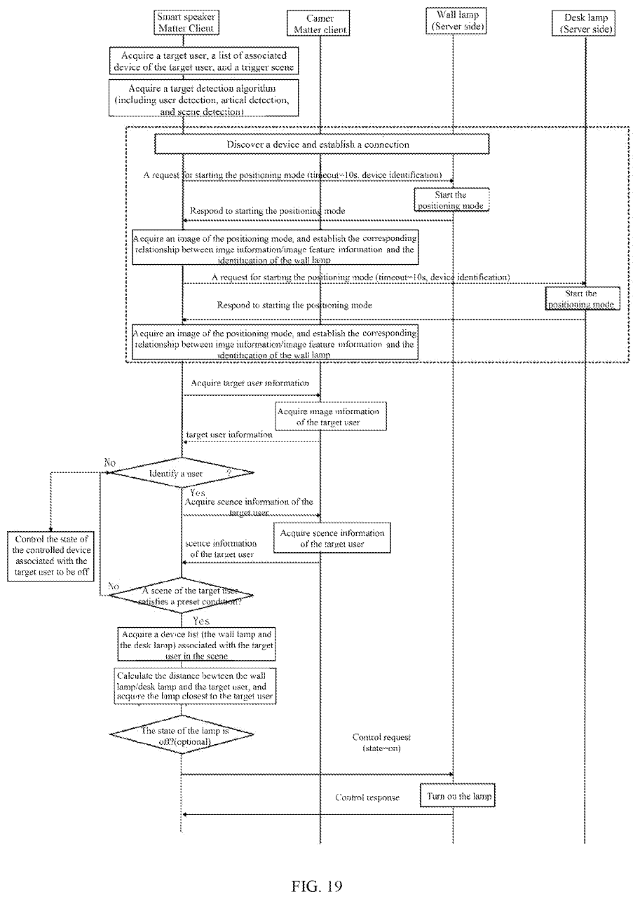

A third logic flow diagram of a device control method provided by the present disclosure is shown with reference to FIG. 19.

A smart speaker acquires information such as a target user, a device associated with the target user, and a trigger scene. Specifically, a user sets the target user, the device associated with the target user, and the trigger scene via a smart speaker server, and the smart speaker acquires the above-mentioned information from the smart speaker server. Optionally, the user connects to a smart speaker via a local network to set the target user, the device associated with the target user, and the trigger scene.

The smart speaker acquires a target detection algorithm (including user detection, article detection, and scene detection) according to the information set by the user, such as the target user, the device associated with the target user, and the trigger scene.

When the device associated with the target user input by the user is device type (for example, a lighting device), the smart speaker discovers a device of a specific device type via a discovery protocol. Specifically, the device broadcasts a device message via the DNS-SD, and the smart speaker discovers the device via the DNS-SD, so that the smart speaker may interact with the device and record relevant information about the device, including information such as an identifier and a function: the smart speaker sends a request for starting a positioning mode, and the request includes a device identification: in the positioning mode, the device highlights itself by means of light, sound, etc., so that the camera can determine the position of the device; the smart speaker acquires image information about the device via a camera, and the smart speaker establishes a corresponding relationship between device images/device image features and device identifications.

When the device associated with the target user input by the user is a device identification list, the smart speaker sends a request for starting the positioning mode, and the request includes a device identification: in the positioning mode, the device highlights itself by means of light, sound, etc., so that the camera can determine the position of the device: the smart speaker acquires image information about the device via the camera, and the smart speaker establishes a corresponding relationship between device images/device image features, and device identifications.

The smart speaker triggers the camera to acquire the image information about the target user, and identifies the current user as the target user: if the target user is identified, the next step is executed: otherwise, the state of the controlled device associated with the target user is controlled to be off.

The smart speaker triggers the camera head to acquire scene information about the target user, and determines whether the scene of the target user satisfies a pre-set condition: if the pre-set condition is satisfied, then the next step is executed, otherwise, a step of identifying the target user is executed. Specifically, the scene information about the target user is identified, the scenes in a family are firstly classified, and image samples from different classification scenes are acquired respectively, and the image samples are labeled: the camera or camera server identifies the classified images through a deep neural network system to form a depth identification algorithm.

The smart speaker acquires a list of devices (for example, a wall lamp and a desk lamp) associated with the target user in the scene.

The smart speaker calculates the distance between the associated device and the target user, and acquires an identification of an associated device closest to the target user (there may be multiple associated devices within a certain threshold). Optionally, the smart speaker or the camera acquires a three-dimensional coordinate of the lamp, and determines the distance between the lamp and the target user by calculating the three-dimensional coordinate of the lamp and the three-dimensional coordinate of the user: the smart speaker or the camera determines a list of devices for which the distance to the current position of the target user is less than a certain threshold. When there is only one device in the list of devices, the device is controlled to be enabled: when multiple devices are presented in the list of devices, one of the devices is randomly selected to be enabled.

Optionally, the state determined by the smart speaker is off, and the next step is executed when the state is off.

The smart speaker sends a control request to enable a lamp, for example, enabling a desk lamp closest to the target user. Optionally, the smart speaker acquires the data of other sensors, and adjusts the parameter of the terminal device being controlled, for example adjusting a brightness of the lamp.

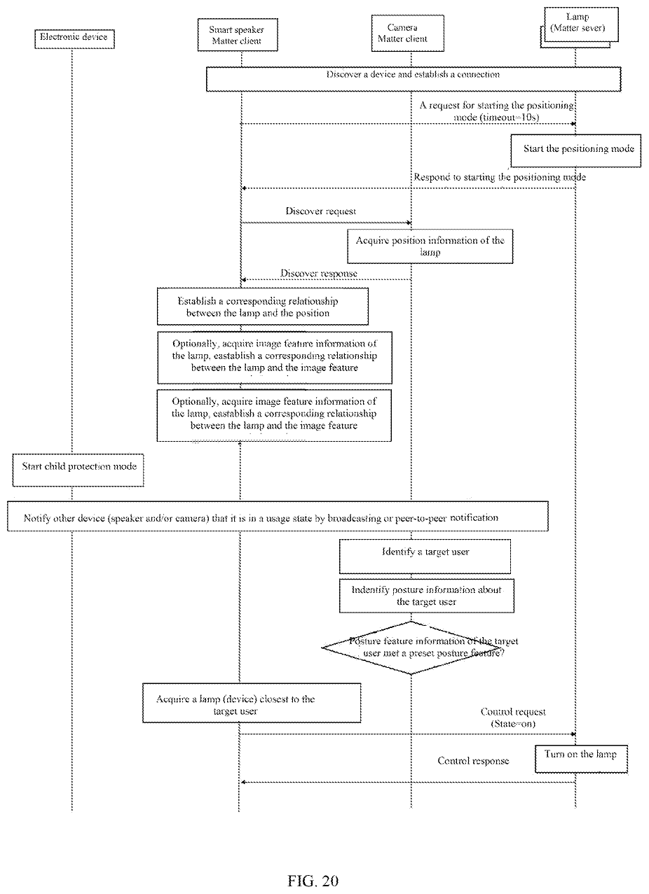

A fourth logic flow diagram of a device control method provided by the present disclosure is shown with reference to FIG. 20.

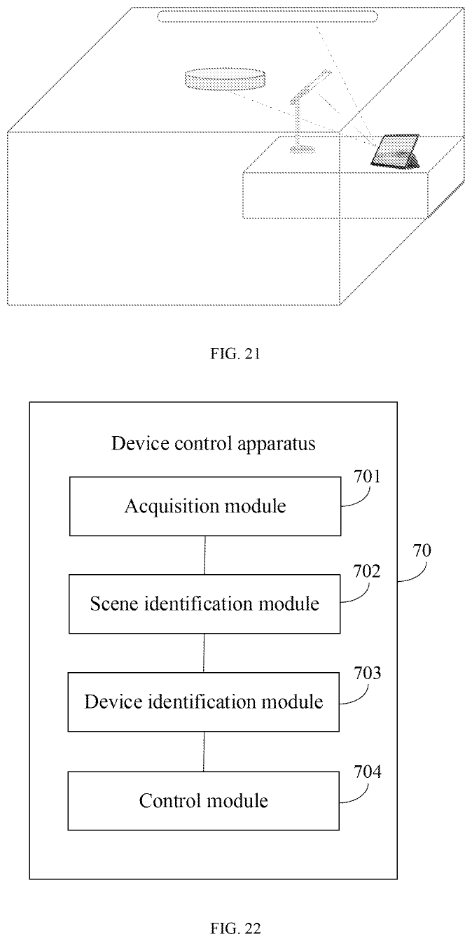

With reference to a reading application scenario of FIG. 21, in the case that an electronic product starts a vision protection mode, especially a child vision protection mode, when the electronic device is powered on by a child, the electronic device sends a control instruction to devices of a lamp type to request the devices of the lamp type to send a Bluetooth signal or a UWB pulse signal; the electronic device determines angles of different lamps by calculating an angle of arrive (AOA) between the devices of different lamp types and the electronic device. In addition, the distance between electronic device and the lamp is calculated by determining the strength of the signal. A lamp with a small AOA angle and a short distance is preferentially selected as a target lamp, and the target lamp is controlled to be powered on.

The smart speaker discovers a lamp and establishes a connection with the lamp. Specifically, the device broadcasts a device message via the DNS-SD, and the camera discovers the device via the DNS-SD so as to be able to interact with the device, and the camera records relevant information about the device, including information such as an identifier and a function.

The smart speaker triggers the lamp to start a positioning mode, and the smart speaker invokes the camera to discover the device, establishes a corresponding relationship between the device and the device position. Specifically, a corresponding relationship between the device identification and the device position is established. Optionally, the positioning mode is automatically started after the device is provided with networks, the device broadcasts via the DNS-SD that it is in the positioning mode, the networking device invokes a camera to acquire device position information, and the camera records the position information about the device (a horizontal angle and a vertical angle of the camera, and a coordinate of the camera in the current image).

The electronic device starts a child protection mode.

The electronic device notifies other device (a speaker and/or a camera) that it is in the usage state by means of broadcasting or peer-to-peer notification. Optionally, after receiving a child protection mode notification message, the target device notifies a smart speaker or a camera if the device control is supported; optionally, the smart speaker and the camera are stored with a list of devices supporting the child protection mode.

The smart speaker or camera acquires the position of the electronic device from the strength of a Bluetooth signal AOA or a UWB pulse signal.

The smart speaker and/or the camera acquires identity feature information about the target user so as to identify the target user, for example, acquiring an image or a video containing a child's head so as to acquire facial feature information about the child by calculation. Optionally, a user is connected to a camera server via a mobile terminal, and identity feature information about the target user is configured via a camera server, which can be implemented in a manner of submitting an image or a video; if the server has saved the image or video of the target user, it can be set in a selected manner. Optionally, the user may directly connect to a camera via a mobile terminal, and configure identity feature information about the target user via the mobile terminal.

The smart speaker and/or the camera acquires state feature information about the target user, for example, acquiring an image or a video containing a child's posture so as to acquire feature information about the child's posture through calculation. For example, an image or video of a child in the state of reading books, doing homework, playing with a platform is acquired, so as to calculate feature information contained in the image or video. Optionally, a user is connected to the camera server via a mobile terminal, and posture feature information about the target user is configured via the camera server, which can be implemented in a manner of submitting an image or a video, and if the server has saved the image or video of the target user, it can be set in a selected manner. Optionally, the user may directly connect to the camera via a mobile terminal, and configure posture feature information about the target user via the mobile terminal.

The smart speaker or the camera identifies the target user and the state information about the target user, and the next step is executed when the state information about the target user meets the pre-set state feature information; when it is not detected that the target user or the state information about the target user does not comply with the pre-set state feature information, a request to turn off the terminal device being controlled is sent, and the state of the terminal being controlled is off.

The smart speaker or the camera calculates the distance between a lamp and a target user, and acquires the lamp closest to the target user; optionally, the smart speaker or the camera acquires a three-dimensional coordinate of the lamp, and determines the distance between the lamp and the target user by calculating the three-dimensional coordinate of the lamp and the three-dimensional coordinate of the user; the smart speaker or the camera determines a list of devices for which the distance to the current position of the target user is less than a certain threshold; when there is only one device in the list of devices, the device is controlled to be enabled; when multiple devices are presented in the list of devices, one of the devices is randomly selected to be enabled.

The smart speaker or the camera sends a control request to control the turning on and turning off of the lamp. Optionally, the smart speaker and the camera acquire the data of other sensors, and adjust the parameter of the terminal device being controlled, for example adjusting the brightness of the lamp.

FIG. 22 is a schematic structural diagram schematically illustrating a device control apparatus 70 provided by the present disclosure, including:
an acquisition module 701, configured to acquire a scene image of a target space;
a scene identification module 702, configured to acquire a target scene type matching a target object in the scene image;
a device identification module 703, configured to acquire a target device associated with the target object shown in the scene image; and
a control module 704, configured to control the target device according to a device control strategy.

Optionally, the control module 704 is further configured to:
acquire a device image of the target device;
acquire a corresponding relationship between device images and device identifications;
determine the device identification of the target device according to the corresponding relationship between device images and device identifications; and
send a control instruction carrying the device identification to the target device to control the target device.

The control module 704 is further configured to:
acquire a device image feature of the target device;
acquire a corresponding relationship between device image features and device identifications;
determine the device identification of the target device according to the corresponding relationship between device image features and device identifications; and
send a control instruction carrying the device identification to the target device to control the target device.

Optionally, the apparatus further includes a configuration module configured to:
establish the corresponding relationship between device identifications and device images; or
establish the corresponding relationship between device identifications and device image features.

Optionally, the configuration module is further configured to:
acquire a device identification;
trigger a device to start a positioning mode and acquire the device image of the device; and
establish a corresponding relationship between device images and device identifications.

The configuration module is further configured to:
acquire a device identification;
trigger the device to start a positioning mode and acquire the device image of the device;
acquire a device image feature of the device from the device image; and
establish a corresponding relationship between device image features and device identifications.

Optionally, the configuration module is further configured to:
acquire a device image of a device;
identify a device type of the device;
acquire a device identification of the device type through a device discovery command; and
establish a corresponding relationship between device images and device identifications.

The configuration module is further configured to:
acquire a device image of the device;
acquire a device image feature of the device from information about the device image;
identify a device type of the device;
acquire a device identification of the device type through a device discovery command; and
establish a corresponding relationship between device image features and device identifications.

Optionally, the control module 704 is further configured to:
acquire a device spatial position of the target device;
acquire a corresponding relationship between device spatial positions and device identifications;
determine the device identification of the target device according to the corresponding relationship between device spatial positions and device identifications; and
send a control instruction carrying the device identification to the target device to control the target device.

Optionally, the apparatus further includes a configuration module configured to:
acquire a device spatial position of the device; and
establish a corresponding relationship between device identifications and device spatial positions.

Optionally, the control module 704 is further configured to:
acquire the device spatial position of the device according to a horizontal position and a vertical position of the image acquisition device and the position of the device in the image.

Optionally, the device identification module 703 is further configured to:
identify at least one candidate device associated with the target object in the scene image; and
screen out at least one target device satisfying a device control condition from the at least one candidate device.

Optionally, the device identification module 703 is further configured to:
calculate a spatial distance between each candidate device and the target object in the scene image; and
take the candidate device having a spatial distance less than the first threshold as the target device.

Optionally, the device identification module 703 is further configured to:
calculate a spatial distance between each candidate device and the target object in the scene image; and
take a candidate device that is turned off and has a distance to the target object less than a second threshold as the target device.

Optionally, the control module 704 is further configured to:
acquire a device control strategy corresponding to the target scene type; and
control at least one target device to switch from the current operation state to a target operation state according to the device control strategy.

Optionally, the scene identification module 702 is further configured to:
identify an object in the scene image;
when the object is identified as the target object, perform a scene identification on the scene image to obtain a scene type; and
take the scene type as a target scene type.

Optionally, the scene identification module 702 is further configured to:
obtain a scene type by performing a scene identification on the scene image;
identify an object in the scene image; and
when the object is identified as a target object, take the scene type as the target scene type.

Optionally, the scene identification module 702 is further configured to:
input the scene image into a scene identification model for identification, and obtain the scene type of the scene image.

Optionally, the scene identification module 702 is further configured to:

input a user posture feature in the scene image into a posture identification model for identification, and obtain the scene type corresponding to the current posture of a character.

Optionally, the scene identification module 702 is further configured to:
identify an object contained in the scene image; and
when there are at least two objects, take the object with the highest priority as the target object.

Optionally, the acquisition module 701 is further configured to:
receive a usage state notification message sent by a user through a device; and
in response to the usage state notification message, trigger an execution of device control.

Optionally, the acquisition module 701 is further configured to:
acquire a scene image of the target space from an image acquisition device in the target space;
or, shoot the target space to obtain the scene image.

According to the embodiments of the present disclosure, a scene image of the target space is shot, a scene type where a target object is located is automatically determined after the target object enters the target space, and a device control strategy is adopted to control the device associated with the target object, so as to adapt to the scenario that the usage scenario of different users automatically controls the device associated with the user, making it easy to control the electronic device without requiring a user to conduct operations during each use.

The above-described device embodiments are merely illustrative. The units described as separate components may or may not be physically separated, and the components displayed as units may or may not be physical units, that is, they may be located in one place, or they may be distributed on multiple network units. Some or all of the modules can be selected according to actual needs to achieve the purpose of the scheme of the embodiment. Those skilled in the art would understand and practice that without involving any creative effort.

Various component embodiments of the present disclosure may be implemented in hardware, or in a software module running on one or more processors, or in a combination thereof. Technicians in this field should understand that microprocessors or digital signal processors (DSPs) can be used in practice to achieve some or all functions of some or all components in the computing processing device according to embodiments of the present disclosure. The present disclosure may also be embodied as device or device programs (e.g., computer programs and computer program products) for executing a portion or all of the methods described herein. Such a program implementing the present disclosure may be stored on a non-transitory computer-readable medium, or may have one or more signal forms. Such signals may be downloaded from an Internet website, provided on a carrier signal, or provided in any other form.

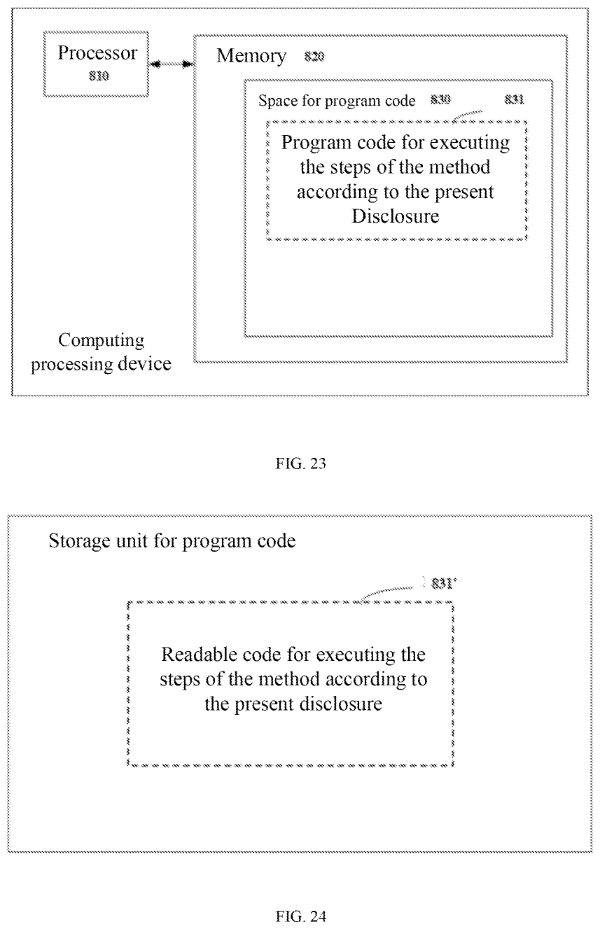

For example, FIG. 23 illustrates a computing processing device that may implement a method according to the present disclosure. The computing processing device conventionally includes a processor 810 and a computer program product or non-transitory computer readable medium in the form of a memory 820. The memory 820 may be an electronic memory such as flash memory, EEPROM (Electrically Erasable Programmable Read Only Memory), EPROM, hard disk, or ROM. The memory 820 has a storage space 830 for program code 831 for executing any of the method steps in the above-described methods. For example, the storage space 830 for a program code may include program code 831 for respectively implementing various steps in the above method. These program codes may be read from or written to one or more computer program products. These computer program products comprise a program code carrier such as a hard disk, a compact disc (CD), a memory card, or a floppy disk. Such a computer program product is typically a portable or fixed storage unit as described with reference to FIG. 24. The storage unit may have a storage section, a storage space, etc. arranged similarly to the memory 820 in the computing processing device of FIG. 23. The program code may, for example, be compressed in a suitable form. In general, the storage unit includes a computer readable code 831′, i.e., a code that can be read by a processor such as 810. These codes, when operated by computing processing device, cause the computing processing device to execute various steps in the methods described above.

It should be understood that, although the various steps in the flowcharts of the drawings are shown in order as indicated by the arrows, the steps are not necessarily executed in the order in sequence indicated by the arrows. The steps are executed in no strict order unless explicitly stated herein, and may be executed in other orders. Moreover, at least some of the steps in the flowcharts of the drawings may include multiple sub-steps or stages, and these sub-steps or stages are not necessarily executed and completed at the same time, but may be executed at different times. The execution sequence is not necessarily sequential, and can be executed in turn or alternately with at least a portion of other steps or sub-steps or stages of other steps.

Reference herein to “one embodiment”, “an embodiment”, or “one or more embodiments” means that a particular feature, structure, or feature described in connection with the embodiment is included in at least one embodiment of the present disclosure. In addition, please note that the word example “in one embodiment” does not necessarily refer to the same embodiment.

In the description provided herein, numerous specific details are set forth. However, it could be understood that embodiments of the disclosure may be practiced without these specific details. In some instances, well-known methods, structures, and techniques have not been shown in detail in order not to obscure the understanding of this description.

In the claims, any reference sign placed in a bracket shall not be construed as limiting the claims. The word “comprising” does not exclude the presence of an element or a step other than those listed in a claim. The word “a” or “one” preceding an element does not exclude the presence of multiple such elements. The disclosure can be implemented by means of hardware comprising several distinct elements, and by means of a suitably programmed computer. In a unit claim enumerating several devices, several devices of these devices can be specifically embodied by one and the same item of hardware. The use of the words first, second, third, etc. does not denote any order. These words may be interpreted as names.

Finally, it should be noted that: the above embodiments are provided only to illustrate the technical solutions of the present disclosure, not to limit it; while the present disclosure has been described in detail with reference to the foregoing embodiments, those of ordinary skills in the art should understand that; the technical solutions disclosed in the above-mentioned embodiments can still be modified, or some of the technical features can be replaced by equivalents; such modifications and substitutions do not make the essence of the corresponding technical solutions depart from the spirit and scope of the technical solutions of the embodiments of the present disclosure.

1. A device control method, comprising:
acquiring a scene image of a target space;
acquiring a target scene type matching a target object in the scene image;
acquiring a target device associated with the target object shown in the scene image; and
controlling the target device according to a device control strategy.

2. The method according to claim 1, wherein the controlling the target device according to a device control strategy comprises:
acquiring a device image of the target device;
acquiring a corresponding relationship between device images and device identifications;
determining a device identification of the target device according to the corresponding relationship between device images and device identifications; and
sending a control instruction carrying the device identification to the target device to control the target device; or
the controlling the target device according to a device control strategy comprises:
acquiring a device image feature of the target device;
acquiring a corresponding relationship between device image features and device identifications;
determining a device identification of the target device according to the corresponding relationship between device image features and device identifications; and
sending a control instruction carrying the device identification to the target device to control the target device.

3. (canceled)

4. The method according to claim 2, wherein before acquiring the device image of the target device, the method further comprises at least one of:
establishing the corresponding relationship between device identifications and device images; and
establishing the corresponding relationship between device identifications and device image features.

5. The method according to claim 4, wherein the establishing the corresponding relationship between device identifications and device images comprises:
acquiring the device identification;
triggering a device to start a positioning mode and acquiring the device image of the device; and
establishing the corresponding relationship between device images and device identifications;
the establishing the corresponding relationship between device identifications and device image features comprises:
acquiring the device identification;
triggering the device to start the positioning mode and acquiring the device image of the device;
acquiring the device image feature of the device from the device image; and
establishing the corresponding relationship between device image features and device identifications.

6. The method according to claim 4, wherein the establishing the corresponding relationship between device identifications and device images comprises:
acquiring the device image of the device;
identifying a device type of the device;
acquiring the device identification of the device type through a device discovery command; and
establishing the corresponding relationship between device images and device identifications;
the establishing the corresponding relationship between device identifications and device image features comprises:
acquiring the device image of the device;
acquiring the device image feature of the device from information about the device image;
identifying the device type of the device;
acquiring the device identification of the device type through a device discovery command; and
establishing the corresponding relationship between device image features and device identifications.

7. The method according to claim 1, wherein the controlling the target device according to a device control strategy comprises:
acquiring a device spatial position of the target device;
acquiring a corresponding relationship between device spatial positions and device identifications;
determining a device identification of the target device according to the corresponding relationship between device spatial positions and device identifications; and
sending a control instruction carrying the device identification to the target device to control the target device.

8. The method according to claim 7, wherein before acquiring the device spatial position of the target device, the method further comprises:
acquiring device spatial positions of devices; and
establishing the corresponding relationship between device identifications and device spatial positions.

9. The method according to claim 8, wherein the acquiring device spatial positions of devices comprises:
acquiring the device spatial positions of the devices according to a horizontal position and a vertical position of an image acquisition device as well as positions of the devices in an image.

10. The method according to claim 1, wherein the acquiring a target device associated with the target object shown in the scene image comprises:
identifying at least one candidate device associated with the target object in the scene image; and
screening out at least one target device satisfying a device control condition from the at least one candidate device.

11. The method according to claim 10, wherein the screening out at least one target device satisfying a device control condition from the at least one candidate device comprises:
calculating a spatial distance between each candidate device and the target object in the scene image; and
taking the candidate device having the spatial distance less than a first threshold as the target device.

12. The method according to claim 10, wherein the screening out at least one target device satisfying the device control condition from the at least one candidate device comprises:
calculating a spatial distance between each candidate device and the target object in the scene image; and
taking a candidate device that is turned off and has a distance to the target object less than a second threshold as the target device.

13. The method according to claim 1, wherein the controlling the target device according to a device control strategy comprises:
acquiring a device control strategy corresponding to the target scene type; and
controlling the at least one target device to switch from a current operation state to a target operation state according to the device control strategy.

14. The method according to claim 1, wherein the acquiring a target scene type matching a target object in the scene image comprises:
identifying objects in the scene image;
when an object is identified as the target object, performing a scene identification on the scene image to obtain the scene type; and
taking the scene type as the target scene type.

15. The method according to claim 1, wherein the acquiring a target scene type matching a target object in the scene image comprises:
performing a scene identification on the scene image to obtain the scene type;
identifying objects in the scene image; and
when an object is identified as the target object, taking the scene type as the target scene type.

16. The method according to claim 14, wherein the performing a scene identification on the scene image comprises at least one of:
inputting the scene image into a scene identification model for identification, and obtaining the scene type of the scene image; or
inputting a user posture feature in the scene image into a posture identification model for identification, and obtaining the scene type corresponding to a current posture of a character.

17. (canceled)

18. The method according to claim 14, wherein the object being identified as the target object comprises:
identifying objects contained in the scene image; and
when there are at least two objects, taking an object with a highest priority as the target object.

19. The method according to claim 1, wherein before acquiring a scene image of a target space, the method further comprises:
receiving a usage state notification message sent by a user through a device; and
in response to the usage state notification message, triggering an execution process of device control.

20. The method according to claim 1, wherein the acquiring a scene image of a target space comprises:
acquiring the scene image of the target space from an image acquisition device in the target space; or
obtaining the scene image by shooting the target space.

21. (canceled)

22. A computing processing device, comprising:
a memory storing with computer readable codes; and
one or more processors, wherein when the computer readable codes are executed by the one or more processors, the computing processing device executes operations of:
acquiring a scene image of a target space;
acquiring a target scene type matching a target object in the scene image;
acquiring a target device associated with the target object shown in the scene image; and
controlling the target device according to a device control strategy.

23. (canceled)

24. A non-transient computer-readable medium storing a computer program of the device control method according to claim 1.
